(19) United States
(12) Patent Application Publication
(10) Pub. No.: US 2018/0080808 A1
(43) Pub. Date: Mar. 22, 2018

(54) DEVICE FOR MEASURING THE LEVEL OF A LIQUID

(71) Applicant: Plastic Omnium Advanced Innovation and Research, Bruxelles (BE)

(72) Inventors: Volodia NAYDENOV, Louvain-la-Neuve (BE); Romain HERDIER, Uccle (BE)

(73) Assignee: Plastic Omnium Advanced Innovation and Research, Bruxelles (BE)

(21) Appl. No.: 15/564,545

(22) PCT Filed: Apr. 7, 2016
(86) PCT No.: PCT/EP2016/057623

§ 371 Date: Oct. 5, 2017

(30) Foreign Application Priority Data
Apr. 8, 2015 (FR) 1553033
Jun. 24, 2015 (FR) 1555806

(51) Int. Cl. G01F 23/26

(52) U.S. Cl. CPC G01F 23/265; G01F 23/268

(57) ABSTRACT

A device for measuring a level of a liquid in a vehicle tank including at least one capacitive probe, the capacitive probe including a support structure supporting at least one plurality of capacitive elements arranged to form at least two rows of capacitive elements extending along a longitudinal axis, the rows of capacitive elements being spaced apart along an axis which is transverse to the longitudinal axis. The capacitive elements of the two rows of capacitive elements are offset along the longitudinal axis with respect to one another from one row to the next.

The invention relates to a device for measuring the level of a liquid in a tank of a vehicle. The invention is in particular applicable to a tank for storing fuel or for storing a liquid for cleaning up exhaust gases, such as for example a urea-based solutions such as AdBlue® (registered trademark). The invention also relates to a vehicular or tank comprising such a device.

Vehicular tanks, in particular fuel tanks, generally incorporate a plurality of measuring devices, including a device for measuring the level of a liquid.

One known device for measuring the level of a liquid is based on the use of a segmented capacitive probe. Such a probe comprises a plurality of capacitive segments that are placed above one another at regular intervals. Each segment is formed by interdigitated electrodes. Such a device is for example described in patent document EP 2 657 663. This device has a number of drawbacks, such as for example the fact that the dielectric constant of the liquid has an impact on the measured level. Generally, the dielectric constant of the liquid varies during its use. A second drawback is that the sensitivity and resolution of the sensor depend on the geometry and dimensions of the segments, on the distance between the electrodes and on the area of the electrodes. Thus, with this type of known sensor, it is difficult to obtain a precise measurement of level.

One of the aims of the invention is therefore to provide a device for measuring the level of a liquid that decreases the impact of the dielectric constant of the liquid on the measured level, and that has a higher sensitivity and a better resolution.

Thus, in one particular embodiment of the invention, a device is provided for measuring the level of a liquid in a tank of a vehicle, said device comprising at least one capacitive probe, said capacitive probe comprising a supporting structure supporting at least a plurality of capacitive elements arranged so as to form at least two rows of capacitive elements extending along a longitudinal axis, said at least two rows of capacitive elements being spaced apart from one another along an axis that is transverse to said longitudinal axis. The capacitive elements are such that they are offset along the longitudinal axis with respect to one another from one row to the next.

Thus, a pattern of distribution of the plurality of capacitive elements is proposed, whereby the capacitive elements are offset with respect to one another, from one row to the next, along the longitudinal axis, and whereby each capacitive element is able to generate a capacitance value depending on the level of liquid on the capacitive element. With this pattern of distribution, additional zones for measuring the level of a liquid are created in the space defined between two elements of a given row. The device according to the invention therefore has a high resolution. It will be noted that the resolution of the device for measuring the level of a liquid according to the invention depends on the number of rows of capacitive elements. The higher the number of rows of capacitive elements the better the resolution. For example, in the case where a first row of capacitive elements alone allows a resolution of 4 mm to be achieved, the use of a second row of capacitive elements (in which the capacitive elements are offset along the longitudinal axis with respect to the capacitive elements of the first row) allows a resolution of 2 mm to be obtained; the use of third and fourth rows of capacitive elements allows a resolution of 1 mm to be obtained; etc.

In one particular embodiment, said plurality of capacitive elements may be associated with another plurality of capacitive elements that is arranged in a different pattern of distribution on the supporting structure, such as for example a prior-art pattern of distribution (without offset of the capacitive elements along the longitudinal axis with respect to one another from one row to the next).

A capacitive element comprises at least one excitation electrode and at least one measurement electrode that are separated from each other by an insulating medium, air for example. In one particular embodiment, the capacitive elements may be any geometric shape and may for example be square or round. In another particular embodiment, the capacitive elements may be interdigitated capacitive electrodes.

In one advantageous embodiment, the capacitive probe comprises a supporting structure comprising a first face supporting at least one of said rows of capacitive elements and at least one second face supporting at least one other of said rows of capacitive elements. The rows of capacitive elements are thus advantageously arranged on these at least two faces, but still spaced apart from each other along the longitudinal axis, with the aim of considerably decreasing the width of the supporting structure.

In one particular embodiment, the supporting structure may be a dielectric material, such as for example a glass-fiber-reinforced epoxy resin composite, on which the plurality of capacitive elements, which may be made of copper or any other conductive material, is arranged. These capacitive elements may be fastened to the supporting structure using a printed circuit board (PCB) manufacturing process, which has the advantage of being a manufacturing process that is known and that allows high production at relatively low cost.

In one particular embodiment, the supporting structure may have any geometric shape having two or more faces, such as for example a cubic or pyramidal shape.

Advantageously, at least one section of the supporting structure on which the plurality of capacitive elements is arranged may be protected from chemical attack by the liquid to be measured by virtue of an insulating layer covering said plurality of elements. The insulating layer may be a protective varnish, of a few tens of microns thickness, applied directly to said at least one section of the supporting structure on which the plurality of capacitive elements is arranged. It may also be a plastic of a few hundred microns to several millimeters thickness, overmolded directly on said at least one section of the supporting structure on which the plurality of capacitive elements is arranged. The plastic insulating layer may also be a part that is injection molded separately, into which part the supporting structure may be incorporated. Advantageously, the insulating layer is applied to all the supporting structure on which the capacitive elements are arranged.

Advantageously, the measuring device according to the invention may be surrounded by a protective tube, having at least two apertures in order to let the liquid pass. This tube may be made from (optionally conductive) plastic, for example a plastic from the polyamide category. The protective tube may be a part that is injection molded or extruded separately from the device and into which said device may be incorporated. The protective tube protects the device from mechanical impacts, such as impacts against the walls of the tank for example. It may also be connected to ground, thereby allowing electrostatic and electromagnetic interference to be decreased for the device according to the invention.

In one advantageous embodiment, the device for measuring the level of a liquid in a tank of a vehicle comprises a processing unit configured to:
obtain capacitance values by means of said plurality of capacitive elements;
convert the obtained capacitance values into a binary code depending on at least one switching threshold associated beforehand with each capacitive element; and
generate information relating to the level of the liquid in the tank from said binary code.

It is thus proposed to associate a switching threshold with each capacitive element. The switching threshold associated with a capacitive element according to the invention corresponds to a capacitance value that said capacitive element is able to generate. For example, for a capacitive element allowing a capacitance ranging from 0.25 pF to 1.5 pF to be measured, the switching threshold of said capacitive element may be set to a capacitance value of 0.75 pF. If the capacitance value obtained for said capacitive element during a measurement is 0.5 pF, then the processing unit will convert this capacitance value into a binary code value of 0. In contrast, if the obtained capacitance is 1 pF, the processing unit will convert this capacitance value into a binary code value of 1.

In one particular embodiment, each capacitive element is associated with the same switching threshold. In another particular embodiment, each capacitive element is associated with a different switching threshold. In one particularly advantageous embodiment, each capacitive element is associated with a high switching threshold and a low switching threshold. This makes it possible to improve the noise immunity of the device according to the invention. During the use of a vehicle, the capacitive elements are successively dry, covered or wet, this impacting the minimum and maximum capacitance values of these capacitive elements. The use of high and low switching thresholds allows these variations to be overcome.

The at least one switching threshold is defined depending on the type of liquid to be measured and is stored in the memory of the processing unit. The processing unit processes these capacitance measurements using a preset conversion strategy. For example, this strategy (i.e. processing) consists in comparing each of the obtained capacitance values to the preset switching threshold in order to generate a binary code depending on the converted capacitance values. In other words, the processing unit according to the invention is configured to convert the obtained capacitance values into logic states (or binary code values) that define said final binary code. Next, the unit is configured to determine (or compute) a value of the level of the liquid in the tank. For example, this value may be determined by comparing the generated binary code with a pre-recorded comparative code stored in the memory of the processing unit, and which relates a binary code to a given value of the level of the liquid.

Thus, the device according to the invention acts as a discrete-level gauge. In one particular embodiment, the unit may furthermore be configured to generate information relating to the inclination of the vehicle from said (generated) binary code. To this end, this information may be generated by comparing the generated binary code with a pre-recorded comparative code stored in the memory of the processing unit, which relates a binary code to a given vehicle inclination value.

Advantageously, the supporting structure integrates a network of electrical connections that is configured to connect the plurality of capacitive elements to the processing unit. In this way, the electrical connections integrated into the supporting structure are protected from any chemical attack by the liquid to be measured.

A plurality of embodiments of the invention will now be presented, which embodiments are described by way of nonlimiting example in the description of the figures and with reference to the following drawings, in which:

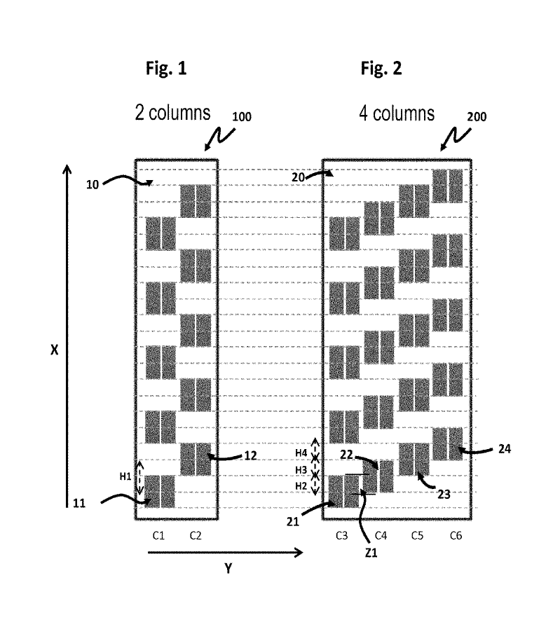

FIG. 1 schematically illustrates a device for measuring the level of a liquid according to a first embodiment of the invention.

FIG. 2 schematically illustrates a device for measuring the level of a liquid according to a second embodiment of the invention.

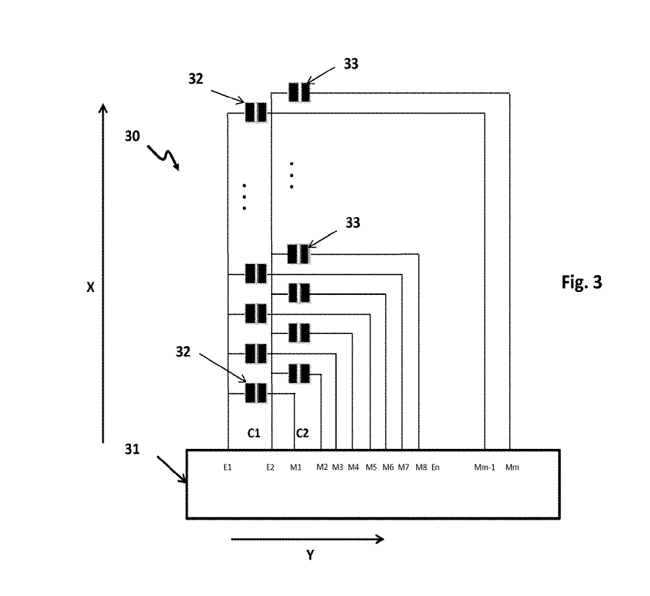

FIG. 3 schematically illustrates a device for measuring the level of a liquid according to the invention.

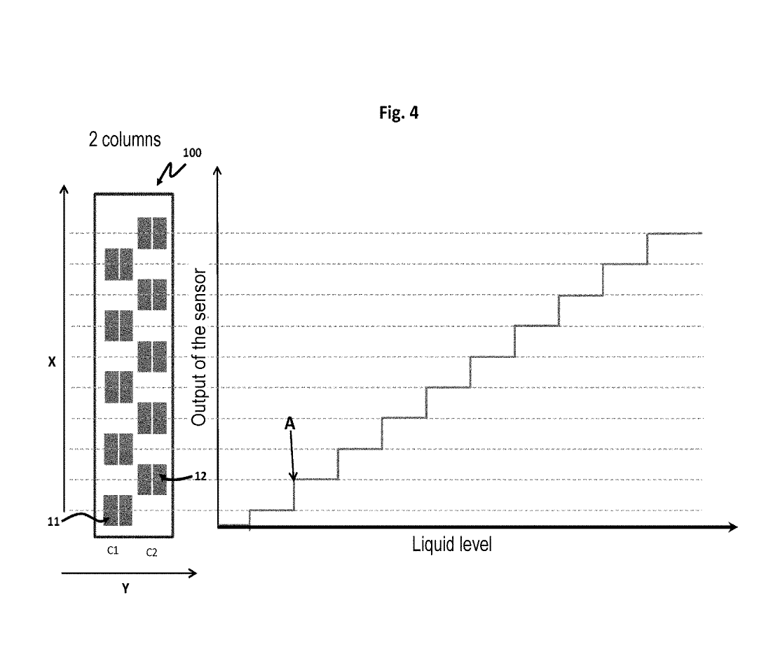

FIG. 4 schematically illustrates processing carried out by the processing unit to generate a binary code in a device for measuring the level of a liquid according to FIG. 1.

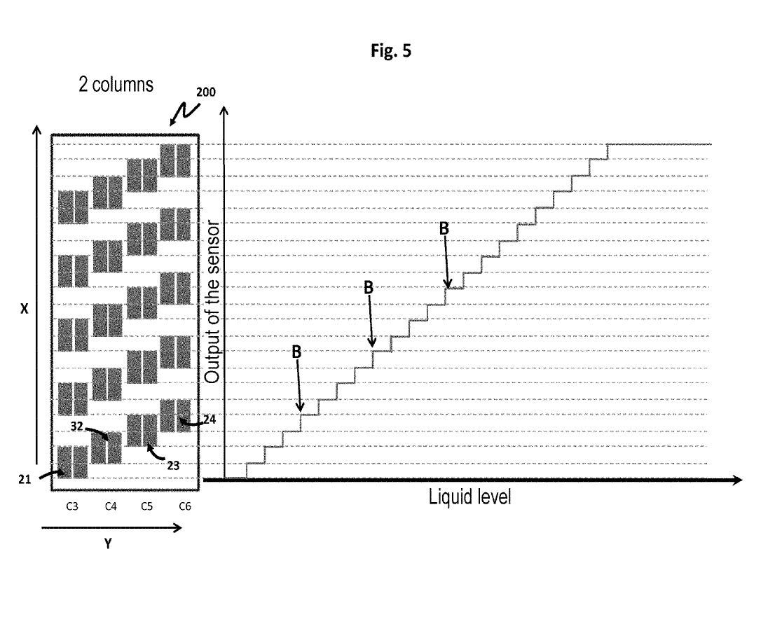

FIG. 5 schematically illustrates processing carried out by the processing unit to generate a binary code in a device for measuring the level of a liquid according to FIG. 2.

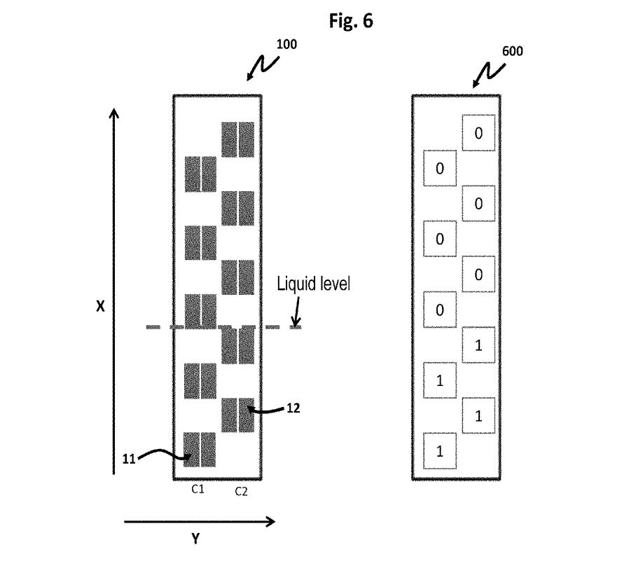

FIG. 6 schematically illustrates a binary code generated from capacitance measurements obtained by means of the device for measuring level of a liquid according to FIGS. 1 and 4.

FIG. 1 schematically illustrates a device 100 for measuring the level of a liquid according to a first embodiment of the invention, which comprises capacitive elements (11, 12) that are arranged on a supporting structure 10 in a first pattern of distribution.

As illustrated in the example of FIG. 1, the device comprises two columns (i.e. rows) (C1, C2) of capacitive elements. Each column contains five capacitive elements that extend along a longitudinal axis X and that are spaced apart from one another along a transverse axis Y. The capacitive elements of the column C2 are offset along a longitudinal axis X by a height H1 with respect to the capacitive elements of the column C1, where H1 corresponds to the resolution of the device. In this example, it will be noted that the capacitive elements 11 of the column C1 are not spatially superposed with the capacitive elements 12 of the column C2.

FIG. 2 schematically illustrates a device 200 for measuring the level of a liquid according to a second embodiment of the invention, which comprises capacitive elements (21, 22, 23 and 24) that are arranged on a supporting structure 20 in a second pattern of distribution.

As illustrated in the example of FIG. 2, the device comprises four columns (i.e. rows) (C3, C4, C5, C6) of capacitive elements. Each column contains five capacitive elements that extend along a longitudinal axis X and that are spaced apart from one another along a transverse axis Y. The capacitive elements 22 of the column C4 are offset along a longitudinal axis X by a height H2 with respect to the capacitive elements 21 of the column C3. The capacitive elements 23 of the column C5 are offset along said longitudinal axis X by a height H3 with respect to the capacitive elements 22 of the column C4. The capacitive elements 24 of the column C6 are offset along said longitudinal axis X by a height H4 with respect to the capacitive elements 23 of the column C5. In the example of FIG. 2, the heights H2, H3 and H4 are equal. In one variant embodiment, the heights H2, H3 and H4 may be different from one another. When H3 and H4 are equal to H2, then H2 corresponds to the resolution of the device. The pattern of distribution illustrated in FIG. 2 is such that the capacitive elements of the columns C3, C4, C5, C6 overlap spatially. For example, the capacitive element 21 of the column C3 and the capacitive element 22 of the column C4 overlap spatially in a zone Z1.

As illustrated in the example of FIG. 3, the device comprises a processing unit 31 that is electrically connected to a plurality of capacitive elements (32, 33) that are arranged in columns (i.e. rows) (C1, C2), the elements extending along a longitudinal axis X and being spaced apart from one another along a transverse axis Y. In this example, the processing unit 31 and the capacitive elements (32, 33) are connected in order to operate in the following way: the processing unit 31 excites the capacitive elements 32 of the column C1 via the signal E1 and then measures the capacitance M of each capacitive element of the column C1. The operating principle is the same for the capacitive elements 33 of the column C2. In this example, the last capacitance value measured is denoted Mm, where m corresponds to the total number of capacitance values to be measured. Therefore, m depends on the height of the capacitive probe (because the greater the height, the greater the number of capacitance elements that will be required to cover all the height) and on the number of columns (because to obtain a high measurement resolution with the device, a plurality of columns of capacitive elements will be required).

FIG. 4 schematically illustrates processing carried out by the processing unit to generate a binary code depending on capacitance measurements generated by the device 100 described above with reference to FIG. 1.

In the example shown in FIG. 4, the step A of the curve corresponds to the moment when the liquid level is such that the measured capacitance of the capacitive element (12) in question is lower than or equal to the switching threshold. Once this switching threshold has been reached, the binary code value that the processing unit attributes to this capacitive element depends on the variation in the level of the liquid. It will be noted that in this example, an additional zone has been created for measuring the level of a liquid in the space defined between two capacitive elements 11 of the column (i.e. rows) C1, which corresponds to an additional piece of information as regards the level of the liquid with respect to the prior art.

FIG. 5 schematically illustrates processing carried out by the processing unit to generate a binary code depending on capacitance measurements generated by the device 200 described above with reference to FIG. 2.

In the example shown in FIG. 5, each step B of the curve also corresponds to the moment when the liquid level is such that the measured capacitance of the capacitive element in question is equal to the switching threshold. Once this switching threshold has been reached, the binary code value that the unit attributes to this capacitive element depends on the variation in the level of the liquid. In this example, it will be noted that three additional zones have been created for measuring the level of a liquid in the space defined between two capacitive elements 21 of the column (i.e. rows) C4, which correspond to three additional pieces of information as regards the level of the liquid with respect to the prior art. Therefore the resolution of the device is considerably improved.

FIG. 6 schematically illustrates a binary code 600 representative of a level of a liquid generated from capacitance measurements obtained with the device 100 described above with reference to FIGS. 1 and 4.

In this example, the level of the liquid is represented by the dashed line. The capacitive elements that are located below this line have capacitance values higher than the switching threshold associated beforehand with each capacitive element, this leading to a binary code value of 1 for each of these capacitive elements. In contrast, the capacitive elements that are located above this line have capacitance values lower than the switching threshold associated beforehand with each capacitive element, this leading to a binary code value of 0 for each of these capacitive elements. Therefore, the binary code obtained in this example is the following: 1111000000.

1-10. (canceled)

11. A device for measuring a level of a liquid in a tank of a vehicle, the device comprising:
at least one capacitive probe, the capacitive probe comprising a supporting structure supporting at least a plurality of capacitive elements arranged to form at least two rows of capacitive elements extending along a longitudinal axis, the at least two rows of capacitive elements being spaced apart from one another along an axis that is transverse to the longitudinal axis,
wherein the capacitive elements of the at least two rows of capacitive elements are offset along the longitudinal axis with respect to one another from one row to the next.

12. The device as claimed in claim 11, further comprising a processing unit configured to:
obtain capacitance values by the plurality of capacitive elements;
convert the obtained capacitance values into a binary code depending on at least one switching threshold associated beforehand with each capacitive element; and
generate information relating to the level of the liquid in the tank from the binary code.

13. The device as claimed in claim 12, wherein each capacitive element is associated with a high switching threshold and a low switching threshold.

14. The device as claimed in claim 12, wherein the processing unit is further configured to generate information relating to inclination of the vehicle from the binary code.

15. The device as claimed in claim 12, wherein the supporting structure integrates a network of electrical connections configured to connect each capacitive element to the processing unit.

16. The device as claimed in claim 11, wherein the supporting structure comprises a first face supporting at least one of the rows of capacitive elements and at least one second face supporting at least one other of the rows of capacitive elements.

17. The device as claimed in claim 11, wherein at least one section of the supporting structure is covered with an insulating layer.

18. The device as claimed in claim 11, further comprising a protective tube comprising at least two apertures and wherein the tube is connected to ground.

19. The device as claimed in claim 11, wherein the liquid is a fuel or a liquid for cleaning up exhaust gases.

20. A vehicular tank for storing a fuel or a liquid for cleaning up exhaust gases comprising a device for measuring the level of a liquid according to claim 11.
